(19) United States
(12) Patent Application Publication
(10) Pub. No.: US 2018/0289221 A1
(43) Pub. Date: Oct. 11, 2018

(54) LIQUID SOAP DISPENSER

(71) Applicant: SERGIO MONTANEZ, TUCSON, AZ (US)

(72) Inventor: SERGIO MONTANEZ, TUCSON, AZ (US)

(21) Appl. No.: 15/947,772

(22) Filed: Apr. 6, 2018

Related U.S. Application Data
(60) Provisional application No. 62/482,262, filed on Apr. 6, 2017.

(51) Int. Cl. A47K 5/12

(52) U.S. Cl. CPC A47K 5/1204; F16B 47/003; A47K 5/1211

(57) ABSTRACT

A liquid soap dispenser that includes: a soap chamber, where the soap chamber includes a spring and a plunger; a supply line connected to the soap chamber at one end and a soap container at a second end, where said spring and plunger are adapted to activate flow of soap from the soap container through the supply line to the soap chamber; a base plate, where the base plate supports the soap chamber; a face plate engaged with the soap chamber, where the face plate; and a soap orifice below the face plate, where the soap orifice supplies a flow of soap from the soap chamber. The liquid soap dispenser may further include a first check valve at the connection of the supply line to the soap chamber and a second check valve, where the second check valve controls flow of soap from the soap orifice.

### CROSS REFERENCE TO OTHER APPLICATIONS

This application claims priority to U.S. Provisional Application Ser. No. 62/482,262 filed on Apr. 6, 2017.

### BACKGROUND OF THE INVENTION

### Field of Invention

The present invention relates to a liquid soap dispenser that assists in the distribution of liquid soap in a shower or bathtub.

### Description of Related Art

Liquid soap is used by many individuals for cleaning purposes. Usually liquid soap is sold in bottles with a pump dispenser that pumps the liquid soap from the container for use. Other liquid containers also include pressure dispensers. Further some other dispensers include a tab that allows for the disbursement of the liquid through the opening through the application of pressure on the outside surface. Many times the liquid dispensers come in various sizes and the bottles can take up a significant amount of space if individuals use liquid soap for body soaps, shampoos and conditioners. Therefore, it would be advantageous to have a liquid dispensing system that could help reduce space requirements for liquid soaps and shampoos and further to aid in the distribution of soap from the manufacturer's container.

### SUMMARY OF THE INVENTION

The present invention relates to a liquid soap dispenser that includes: a soap chamber, where the soap chamber includes a spring and a plunger; a supply line connected to the soap chamber at one end and a soap container at a second end, where said spring and plunger are adapted to activate flow of soap from the soap container through the supply line to the soap chamber; a base plate, where the base plate supports the soap chamber; a face plate engaged with the soap chamber, where the face plate; and a soap orifice below the face plate, where the soap orifice supplies a flow of soap from the soap chamber. The liquid soap dispenser may further include a first check valve at the connection of the supply line to the soap chamber and a second check valve, where the second check valve controls flow of soap from the soap orifice. At least one suction cup on an outer surface of the base plate may be provided to support the soap dispenser on a wall surface. The liquid soap dispenser may also include pad at a lower end of the base plate.

### BRIEF DESCRIPTION OF DRAWINGS

FIG. 1 depicts a focused view of a liquid soap dispenser in accordance with the present invention.

FIG. 2 depicts a front view of the face plate of the present invention.

FIG. 3 depicts a side view of a liquid soap dispenser assembly in accordance with the present invention.

FIG. 4 depicts a liquid soap container of the prior art implementing the present invention.

### DETAILED DESCRIPTION

The present invention relates to a wall-mounted liquid soap dispenser that is integrated with a conventional liquid soap container. The liquid soap dispenser according to the present invention is preferably mounted on an inside wall of a shower or bath enclosure to provide ready access to liquid soap. The liquid soap dispenser according to the present invention provides a means to dispense liquid soap from a conventional soap container. The liquid soap dispenser according to present invention includes a soap chamber with springs and valves to initiate positive pressure into the soap container and deliver the soap from a soap opening or if it's provided on the dispenser.

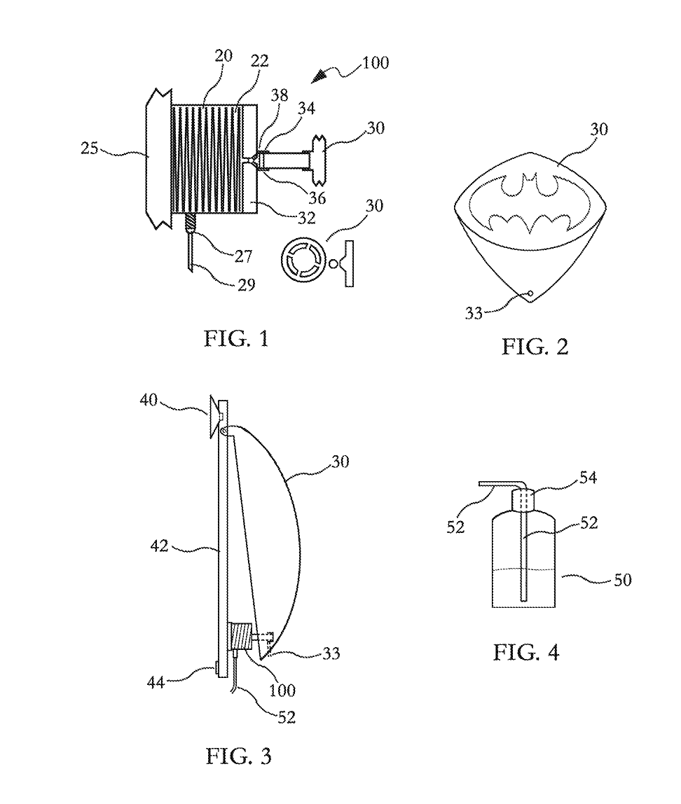

In reference to FIG. 1, a focused view of a liquid soap dispenser according to the present invention is depicted. Within this focus view, a Soap Chamber 20 is depicted that includes a Spring 22 within the Chamber 20. A Plunger 32 is also within the Chamber 20. The Plunger 32 activates the flow of soap from Supply Line 52 through Check Valve 27. This Supply Line 52 is connected to a conventional Soap Container 50 as shown in FIG. 4. The Supply Line 52 is attached to this conventional Soap Container 50 with a Cap 54 where the Soap Container 50 provides the supply of soap fed through the Soap Dispenser 100. Other aspects of Soap Dispenser 100 include attachment to a Base Plate 25, which is shown partially in FIG. 1 that supports the Soap Dispenser 100. Further, an additional Check Valve 38 is shown that includes Retainer 34 and Spring 36 that initiates a flow of soap through the Soap Chamber 20. A Face Plate 30 is seen partially but in full view in FIG. 2. Below the Face Plate 30 is a Soap Orifice 33 that releases soap supplied through the Supply Line 52.

A side view of the liquid soap dispenser assembly is depicted in FIG. 3, where the Face Plate 30 is shown with Dispenser 100 at the lower portion thereof. The Face Plate 30 is depressed and allows the release of soap through Orifice 33. The complete assembly is mounted on a Base Plate 25 that include at least one Suction Cup 40 to adhere the Base Plate 25 onto the shower surface. At the lower end of the Base Plate 25 is a Pad 44 to provide further support of the assembly on a shower wall. This entire assembly is easily attached to a conventional liquid soap container to provide a continuous and effective flow of liquid soap. The instant invention has been shown and described in what it considers to be the most practical and preferred embodiments. It is recognized, however, that departures may be made there from within the scope of the invention and that obvious modifications will occur to a person skilled in the art.

What is claimed is:

1. A liquid soap dispenser comprising:
a. a soap chamber, where the soap chamber includes a spring and a plunger;
b. a supply line connected to the soap chamber at one end and a soap container at a second end, where said spring and plunger are adapted to activate flow of soap from the soap container through the supply line to the soap chamber;
c. a base plate, where the base plate supports the soap chamber;
d. a face plate engaged with the soap chamber, where the face plate; and
e. a soap orifice below the face plate, where the soap orifice supplies a flow of soap from the soap chamber.

2. The liquid soap dispenser according to claim 1, further comprising: a first check valve at the connection of the supply line to the soap chamber.

3. The liquid soap dispenser according to claim 1, further comprising: a second check valve, where the second check valve controls flow of soap from the soap orifice.

4. The liquid soap dispenser according to claim 1, further comprising at least one suction cup on an outer surface of the base plate.

5. The liquid soap dispenser according to claim 2, further comprising a pad at a lower end of the base plate.
